(19) United States
(12) Patent Application Publication
(10) Pub. No.: US 2006/0078642 A1
(43) Pub. Date: Apr. 13, 2006

(54) Apparatus for making patties

(75) Inventor: Jeffrey William Palese, North Ridgeville, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: PRAGOTRADE, INC.

(21) Appl. No.: 11/244,377

(22) Filed: Oct. 5, 2005

Related U.S. Application Data
(60) Provisional application No. 60/616,900, filed on Oct. 7, 2004.

(51) Int. Cl. A01J 21/00

(52) U.S. Cl. 425/416

(57) ABSTRACT

A patty forming apparatus (10) includes a housing (48) that defines a chamber (90). The housing (48) has an open condition for receiving a food product (14) and a closed condition for forming a patty (16) with the food product. The apparatus (10) includes an element (100) for adjusting the volume of the chamber (90) to select the approximate weight of a patty (16) formed when the volume of the chamber (90) is filled with the food product (14).

### RELATED APPLICATION

This application claims the benefit of U.S. Provisional Application No. 60/616,900, filed on Oct. 7, 2004.

### FIELD OF THE INVENTION

The present invention relates to an apparatus for making patties by molding or pressing a ground food product into a desired shape.

### BACKGROUND OF THE INVENTION

Apparatus for molding food products into desired shapes are generally known. Among these apparatus are apparatus for forming a ground meat, such as ground beef, pork, or venison, into a patty. The known apparatus are typically small units that include a single mold cavity. These known apparatus are manually loaded with ground meat and operated manually to press or otherwise form the ground meat into a patty.

### SUMMARY OF THE INVENTION

The present invention relates to a patty forming apparatus a patty forming apparatus that includes a housing that defines a chamber. The housing has an open condition for receiving a food product and a closed condition for forming a patty with the food product. The apparatus includes an element for adjusting the volume of the chamber to select the approximate weight of a patty formed when the volume of the chamber is filled with the food product.

The present invention also relates to a patty forming apparatus including a base including a generally circular base wall. A cover includes a generally cylindrical side wall centered on an axis. A plate member includes a generally circular top wall centered on the axis and movable relative to the side wall along the axis. The cover and the base member are movable relative to the base from an open condition to a closed position. The base wall, side wall, and top wall define a cylindrical chamber when the cover and base member are in the closed position. The position of the plate member is adjustable relative to the housing to select the approximate weight of a patty formed when the chamber is filled with a food product.

The present invention further relates to a patty forming apparatus including a housing that defines a cylindrical chamber having a fixed diameter and an adjustable height. The housing has an open condition for receiving a food product in the chamber. The housing has a closed condition for forming a cylindrical patty with the food product in the chamber. The patty has a diameter that coincides with the fixed diameter of the chamber. The patty has a thickness that coincides with the height of the chamber. The height of the chamber is adjustable to thereby select the approximate weight of the patty.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a perspective view of an apparatus for making patties illustrating the apparatus in a closed condition, according to an embodiment of the present invention;

FIG. 2 is a perspective view of the apparatus for making patties of FIG. 1 illustrating the apparatus in an open condition; and

FIG. 3 is a sectional view of the apparatus for making patties taken generally along line 3-3 in FIG. 1.

### DETAILED DESCRIPTION OF THE INVENTION

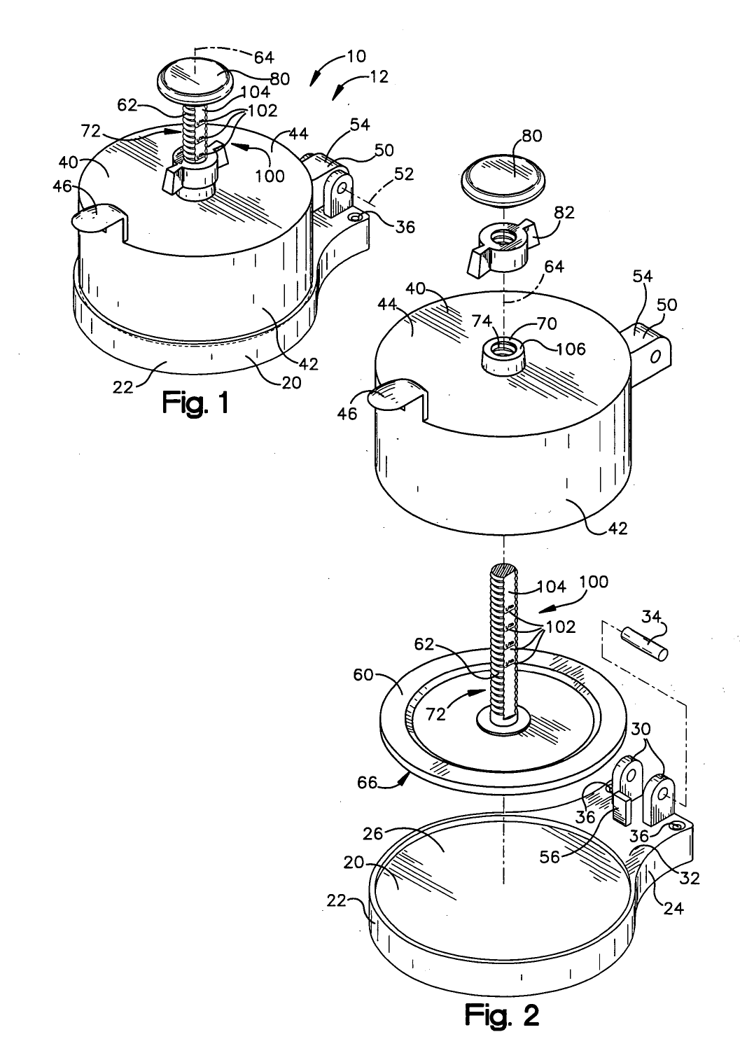

Referring to FIG. 1, the present invention relates to an apparatus 10 in the form of a press 12 for processing a food product into a predetermined form. According to the embodiment of FIGS. 1-3, the press 12 is adapted to receive a food product 14 and press or otherwise mold the food product to form a patty 16. In the illustrated embodiment, the food product 14 is a ground meat product, such as ground beef.

The press 12 includes a base 20 and a cover 40, which together define a housing 48. The base 20 may be formed of any suitable material, such as metal or plastic. For example, the base 20 may have a cast metal or metal alloy (e.g., aluminum) construction. The base 20 has a main portion 22 and a flange portion 24. The main portion 22 has a generally cylindrical configuration and includes a circular bottom wall surface 26 (FIG. 2). As shown in FIG. 2, the bottom wall surface 26 may be recessed in the main portion 22 of the base 20.

The flange portion 24 extends radially from a peripheral edge of the main portion 22. The flange portion 24 includes a pair of spaced hinge pin supports 30 that extend from an upper surface 32 of the flange portion 24. The supports 30 are adapted to receive and support a hinge pin 34. The flange portion 24 may also include one or more apertures 36 for receiving means (not shown), such as a fastener, for connecting the base 20 to a work surface (not shown).

The cover 40 may be formed of any suitable material, such as metal or plastic. For example, the cover 40 may have a cast metal or metal alloy (e.g., aluminum) construction. The cover 40 includes a generally cylindrical side wall 42 and a circular top wall 44. The side wall 42 may have a slightly tapered configuration in which the diameter of the side wall at the bottom end as viewed in the figures, is greater than the diameter at the opposite end.

The cover 40 may also include a handle 46, which may have a variety of configurations. In the illustrated embodiment, the handle 46 has an ergonomically contoured configuration and projects from the cover 40 at the intersection of the side wall 42 and top wall 44. The cover 40 may also include a hinge portion 50 that projects from the side wall 42 radially opposite the handle 46.

The hinge portion 50 is configured and arranged to cooperate with the supports 30 of the base 20 and the pin 34. In the illustrated embodiment, the hinge portion 50 is adapted and configured to be positioned between the supports 30. While the hinge portion 50 is positioned between the supports 30, the pin 34 is extendable through the supports and through the hinge portion. This provides a hinged connection between the cover 40 and the base 20.

The cover 40 is pivotal relative to the base 20 about an axis 52 between an open condition (FIG. 2) to a closed condition (FIG. 1). The hinge portion 50 may have a rounded outer surface 54 that provides a clearance between the hinge portion and the flange portion 24 that facilitates this pivotal movement. The base 20 may include a stop piece 56 that projects from the upper surface 32 of the flange portion 24 and limits pivotal movement of the cover 40 relative to the base 20.

The press 12 also includes a plate member 60. The plate member 60 may be formed of any suitable material, such as metal or plastic. For example, the plate member 60 may have a cast metal or metal alloy (e.g., aluminum) construction. The plate member 60 has a generally circular, disk-shaped configuration and has a diameter that is slightly smaller than the inside diameter of the side wall 42 of the cover 40.

The plate member 60 is operatively connected to a shaft 62 which connects the plate member to the cover 40. The shaft 62 is centered on an axis 64 that coincides with the center of the plate member 60. In the illustrated assembled condition of the press 12, the plate member 60 positioned within the cover 40. In this condition, the shaft 62 extends through a threaded opening 70 in the top wall 44 of the cover 40. The shaft 62 has a threaded outer surface 72 that mates with a threaded inner surface 74 of the opening 70. The shaft 62 is thus movable axially relative to the cover 40 upon rotation about the axis 64.

The plate member 60 is thus supported on the cover 40 by the shaft 62. The plate member 60 is movable relative to the cover 40 and the housing 48 along the axis 64 through rotation of the shaft 62 about the axis 64. The shaft 62 may include a knob 80 for facilitating rotation of the shaft about the axis 64. A threaded member 82, such as a wing nut, may be threaded onto the shaft 62 and may be tightened against the cover 40 in order to help block rotation of the shaft 60 about the axis 64. This locks the position of the plate member 60 relative to the cover 40 and housing 48.

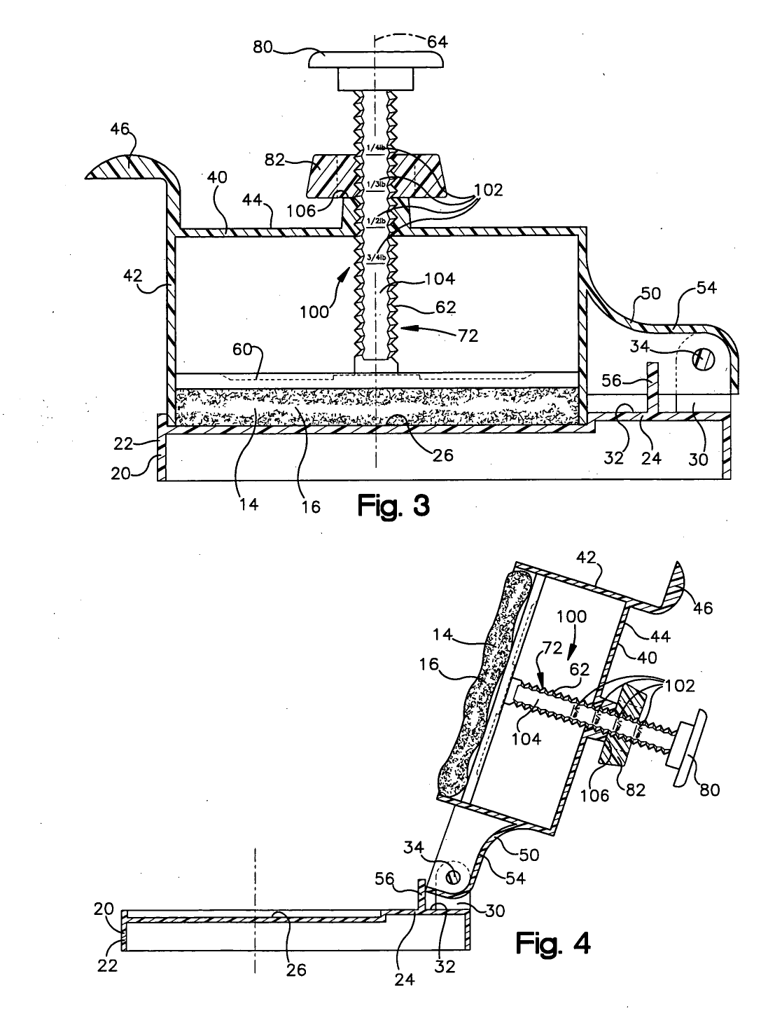

Referring to FIG. 3, the press 12 includes a chamber 90 that is defined by the bottom wall surface 26 of the base 20, the side wall 42 of the cover 40, and a top wall surface 66 of the plate member 60. The chamber 90 thus has a generally cylindrical configuration when the press 12 is in the closed condition of FIGS. 1 and 3.

To form a patty 16 using the press 12, the food product 14 is placed on the bottom surface 26 of the base 20 when the press is in the open condition. A non-stick sheet (not shown), such as wax paper, may be positioned between the bottom surface 26 and the food product 14. Another non-stick sheet (not shown) may be positioned between the food product 14 and the cover 40. The patty 16 is pressed by pivoting the cover 40 to place the press 12 in the closed condition of FIGS. 1 and 3. When this occurs, the food product 14 conforms to the cylindrical shape of the chamber 90, thus forming the patty 16. The non-stick sheets may help facilitate removal of the patty 16 after pressing. Also, the surfaces defining the chamber 90, i.e., the bottom wall surface 26, the side wall 42, and the top wall surface 66 may be coated with a non-stick coating (not shown).

The thickness of the patty 16 is dictated by the axial position of the plate member 60 relative to the cover 40. Since the side wall 42 has a generally cylindrical configuration, the diameter of the patty 16 will remain generally the same, regardless of its thickness. As a result, it will be appreciated that the volume of the chamber 90 is directly proportional to the axial position of the plate member 60. It thus follows that the weight of the patty 16 is directly proportional to the axial position of the plate member 60 relative to the cover 40.

According to the present invention, the press 12 includes means 100 for determining the approximate weight of a patty 16 formed from the food product 14 in the press. The weight determining means 100 comprises the shaft 62 and indicia 102 on the shaft that indicate the approximate weight of a patty 16 formed in the chamber 90 when the plate member 60 is at a given axial position relative to the cover 40. As shown in FIGS. 1-3, the indicia 102 may be inscribed or otherwise marked on a flattened surface 104 of the shaft 62. The flattened surface 104 does not interfere with the threaded engagement between the shaft 60 and the cover 40.

The weight of a patty 16 formed when the plate member 60 is at a given position relative to the cover 40 will vary depending on the density of the food product 14 from which the patty is formed. Thus, the indicia 102 may be accurate for one type of food product 14 and inaccurate for another type of food product. According to the present invention, the indicia 102 is provided to indicate the patty weight for a food product 14 that for which the press 12 is primarily intended. For example, the indicia 102 may indicate the weight of a patty 16 formed from a ground meat (e.g., beef, pork, venison) food product 14. Also, various units of measure, such as pounds, grams, or both, may be indicated by the indicia.

To use the press 12, a user first sets the desired patty weight by rotating the shaft 62 about the axis 64 until the desired weight indicia 102 is aligned with the upper surface 106 adjacent the opening 70 in the top wall 44 of the cover 40. This places the plate member 60 in the position relative to the cover 40 required to provide the corresponding patty weight. The wing nut 82 is then tightened into engagement with the upper surface 106 to lock the shaft 62, and thus the plate member 60, against movement relative to the cover 40. the cover 40 is then placed in the closed position to press the food product 14 into the patty 16. Any excess food product will be displaced outside the chamber 90 and may be cleared away prior to removing the patty 16. The food product 14, when pressed into a patty 16 in the manner described above, will thus have the desired weight as selected by the user via the indicia 102.

From the above description of the invention, those skilled in the art will perceive improvements, changes and modifications in the invention. For example, although the apparatus of the illustrated embodiment includes a single mold chamber for forming patties one at a time, it will be appreciated that the apparatus could include two or more chambers and thereby be capable of forming two or more patties at a time. As another example, the apparatus could be adapted to form patties of shapes other than the illustrated circular (cylindrical) shape, such as square or rectangular. Such improvements, changes and modifications within the skill of the art are intended to be covered by the appended claims.

Having described the invention, I claim:

1. A patty forming apparatus comprising:
a housing defining a chamber, said housing having an open condition for receiving a food product, said housing having a closed condition for forming a patty with the food product; and
volume adjusting means for adjusting the volume of said chamber, said volume adjusting means including weight selecting means for selecting the approximate weight of a patty formed when the volume of said chamber is filled with the food product.

2. The patty forming apparatus recited in claim 1, wherein said volume adjusting means comprises a plate member disposed in said housing and helping to define said chamber, said plate member having a position adjustable relative to said housing to adjust the volume of said chamber.

3. The patty forming apparatus recited in claim 2, wherein said volume adjusting means is operable to adjust the position of said plate member relative to said housing.

4. The patty forming apparatus recited in claim 2, wherein said housing comprises a base and a cover associated with said base, said plate member being secured to said cover by said volume adjusting means, said plate member being movable relative to said cover by said volume adjusting means.

5. The patty forming apparatus recited in claim 4, wherein said base comprises a bottom wall, said cover comprises a side wall, and said plate member comprises a top wall movable relative to said base and said cover, said bottom wall, said side wall, and said top wall defining said chamber.

6. The patty forming apparatus recited in claim 4, wherein said base comprises a generally circular bottom wall centered on an axis, said cover comprises a cylindrical side wall centered on said axis, and said plate member comprises a generally circular top wall centered on said axis and movable along said axis relative to said base and said cover, said bottom wall, said side wall, and said top wall defining said chamber, said chamber having a generally cylindrical configuration.

7. The patty forming apparatus recited in claim 4, wherein said cover is hinged to said base for pivotal movement relative to said base from a first position in which said housing is in said closed condition to a second position in which said housing is in said open condition.

8. The patty forming apparatus recited in claim 2, wherein said volume adjusting means comprises a shaft having a threaded connection with said housing, said shaft being rotatable about an axis to cause movement of said plate member along said axis.

9. The patty forming apparatus recited in claim 8, wherein said weight selecting means comprises indicia on said shaft for selecting the approximate weight of a patty formed when said chamber is filled with the food product.

10. The patty forming apparatus recited in claim 8, wherein said weight selecting means comprises indicia on said shaft for selecting the position of said plate member along said axis to a predetermined position that corresponds with an approximate weight of a patty formed when said chamber is filled with the food product when said plate member is in said predetermined position.

11. The patty forming apparatus recited in claim 1, wherein said food product comprises a ground meat food product.

12. A patty forming apparatus comprising:
a base comprising a generally circular base wall;
a cover comprising a generally cylindrical side wall centered on an axis;
a plate member comprising a generally circular top wall centered on said axis and movable relative to said side wall along said axis, said cover and said base member being movable relative to said base from an open condition to a closed position, said base wall, said side wall, and said top wall defining a cylindrical chamber when said cover and said base member are in said closed position; and
means for adjusting the position of said plate member relative to said housing, said adjusting means including means for selecting the approximate weight of a patty formed when said chamber is filled with a food product.

13. A patty forming apparatus comprising:
a housing defining a cylindrical chamber having a fixed diameter and an adjustable height, said housing having an open condition for receiving a food product in said chamber, said housing having a closed condition for forming a cylindrical patty with the food product in said chamber, said patty having a diameter that coincides with the fixed diameter of said chamber, said patty having a thickness that coincides with the height of said chamber; and
means for adjusting the height of said chamber to thereby adjust the thickness of said patty, said adjusting means comprising means for selecting the approximate weight of said patty.
